(19) United States
(12) Patent Application Publication
(10) Pub. No.: US 2019/0383443 A1
(43) Pub. Date: Dec. 19, 2019

(54) Vehicle glass extractor blade lubricant sprayer

(71) Applicant: Paul W. Vlach, Anderson, CA (US)

(72) Inventor: Paul W. Vlach, Anderson, CA (US)

(21) Appl. No.: 15/998,004

(22) Filed: Jun. 9, 2018

(51) Int. Cl. F16N 7/38; F16N 19/00; C03B 33/10

(52) U.S. Cl. CPC F16N 7/38; C03B 33/105; F16N 19/00

(57) ABSTRACT

A sprayer device to be mounted on the top of a powered vehicle glass extractor gun, for emitting fluid upon actuation to a vehicle glass work site and to a blade mounted in the glass extractor gun, said device having a main body with a retainer front foot there beneath at the distal end, and with a lubricant storage compartment, fluidly connected to a rechargeable battery operated pump, which pump is connected to an input hose from the lubricant storage compartment and the pump is also connected to a second hose extending through the distal end of said body, said second hose having a blade holder thereon, through which a blade for the extractor gun is disposed such that when the device is actuated by an actuator, fluid is sprayed on the extractor gull blade and the work site.

### RELATION TO OTHER APPLICATIONS

This application claims priority from Provisional application 62/603,798 filed Jun. 13, 2017

### FIELD OF INVENTION

This application relates to a sprayer attachment that mounts on preferably an Equalizer brand auto glass removal tool, and other brands of such tools as well, whereby when the sprayer is actuated, water or other lubricant can be sprayed on the blade of the glass removal tool, or on the work area of the glass being removed from the vehicle. Such work areas include the front windshield, the rear window, all of the side windows, and a sunroof glass as well. Any vehicle from small sports car to the largest RV can have the needed glass removed more easily with the use of he lubricant sprayer of this invention.

### BACKGROUND OF THE INVENTION

The autoglass replacement industry replaces windshields and side panes of glass in all types of vehicles everyday in cities large and small across this country and the rest of the car driving world. No doubt many people have heard and seen the commercials of Safelite Glass Corporation on national television. Replacement need can arise due to cracks, and chips caused by golf balls, hail storms, pebbles or rocks, falling trees or branches, and of course vehicle accidents which can cause entire panes of glass to be broken and/or shattered.

One company that makes tools for vehicle glass removal by professionals is Equalizer Industries of Round Rock Tex. The applicant herein is an automotive glass removal and installation specialist who personally uses the BlackOps® 120 volt AC powered tool daily in his work. This invention was originally created to work with the BlackOps power tool; also known as an extractor gun. While originally created to work with battery operated glass extractor tools such as the Equalizer Ambush model, this device will also work with AC powered units such as the Stingray™ glass extractor, as well as air powered tools often found in auto body shops.

### SUMMARY OF THE INVENTION

A device to be used with powered vehicle glass extractors for the removal of windshields, and side panes and sun roof panels by optionally coupling the actuation of the device to emit a lubricant with the action of the blade of the powered glass removal tool. The device is mounted by a selectively designed clamp to the specific brand and the brand's tool, and an electrical connection may be made between the device and the tool. When the sprayer device is actuated, either separately or through the gun itself, lubricant will be sprayed on the tool and the work area.

The spray device features a main body having a compartment to store a lubricant, a rechargeable battery operated pump, an input hose to the pump from the lubricant compartment and an output hose with a nozzle thereon directed at the work site and the blade of the tool doing the glass removal.

It is a first object to provide a lubricating device for the work site where a piece of vehicle glass is being removed.

It is a second object to provide a device that attaches to and whose actuation may be coupled to the operation of the power tool removing the glass from its seated position.

It is a third object to provide a device that can direct lubricant to the glass being removed, to reduce the temperature at the work site and make removal easier.

It is a fourth object to provide a means to cool the blade of a powered glass extractor tool to prolong the life of the blade.

Other objects of the invention will in part be obvious and will in part appear hereinafter.

The invention accordingly comprises the combination of elements, as well as the device discussed herein, all of which are exemplified in the following detailed disclosure, and the scope of the application of which will be indicated in the claims.

### BRIEF DESCRIPTION OF THE FIGURES

FIG. 1 is a right side perspective view of the device of this invention.

FIG. 2 is a left side top perspective view of the device of this invention.

FIG. 3 is a right perspective bottom view of this device.

FIG. 4 is a closeup front perspective view of the sprayer attachment of this invention.

FIG. 5 is a bottom perspective view of this device.

FIG. 6 is a rear elevational view of this sprayer attachment.

FIG. 7 is a front view of the clamp attachment forming part of this invention.

FIG. 8 is a plan view of the top portion and bottom portion of the clamp attachment of FIG. 7

FIG. 9 is a right side view of a typical glass powered glass extractor tool made by Equalizer Industries, Inc. of Round Rock Tex.

FIG. 10 is a left side view of another Equalizer brand glass extractor tool with the device of this invention mounted thereon.

FIG. 11 is a top plan view of this invention with the battery cover removed and threaded cap removed from the body.

FIG. 12 is a plan view showing fluid mist or stream exiting the nozzle and spraying onto the extractor blade.

FIGS. 13A and 13B are diagrammatic views setting forth alternative modes of operation of this device.

FIG. 14 is a perspective view of another clamping unit, to attach the device of this invention to an extractor gun.

### DESCRIPTION OF THE PREFERRED EMBODIMENT

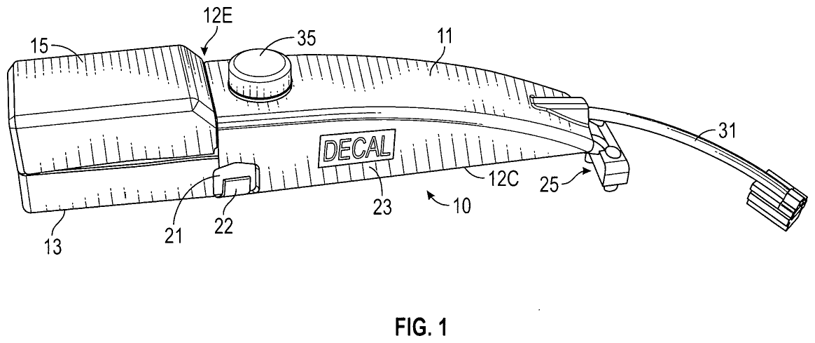

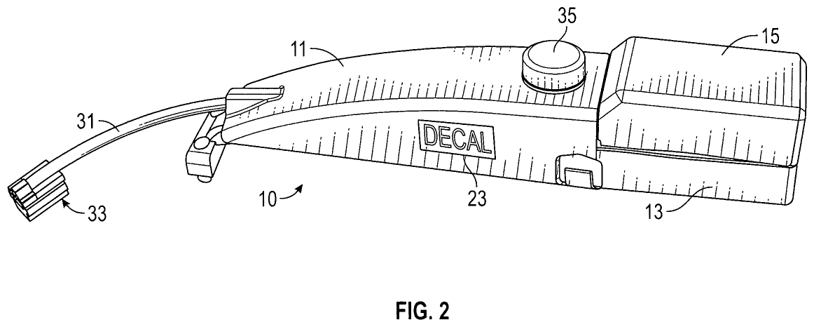

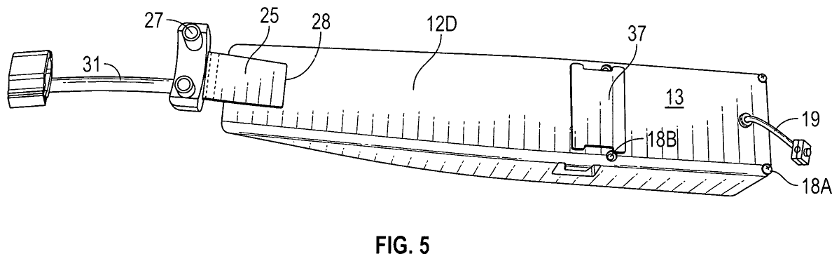

In FIG. 1 there is seen the sprayer attachment of this invention, which is used in conjunction with a powered vehicle glass removal tool when a windshield or other pane of vehicle glass needs replacement. Body 11 has three compartments and has a top surface 12A—FIG. 2-, a right side wall 12C, a left side wall 12B—again FIG. 2-, and a bottom surface 12D—FIG. 5, a closed intermediate rear wall 12E and a front nose 12F. Bottom surface 12D is normal to the rear wall 12E as is the rear area of top wall 12A. The front area of top surface 12A tapers down toward the blunt nose 12F which is of a shorter elevation than rear wall of either side wall of the body 11. Optionally the two side walls can taper slightly from rear toward the front for easier access of the blade in tight spaces.

Top surface 12A has a threaded cap 35 thereon adjacent the rear terminal point of said wall. The purpose of the threaded cap is to retain the water or other lubricant within the confines of the chamber 49 in body 11.

Connected to the lubricant storage compartment at the rear of said body 11 is a pump compartment 13 covered over by a two side open battery cover which defines a battery compartment 15. Also seen in this view is the identifying decal 23 which states the name of the device or other indicia. Front hose 31 will also be discussed infra.

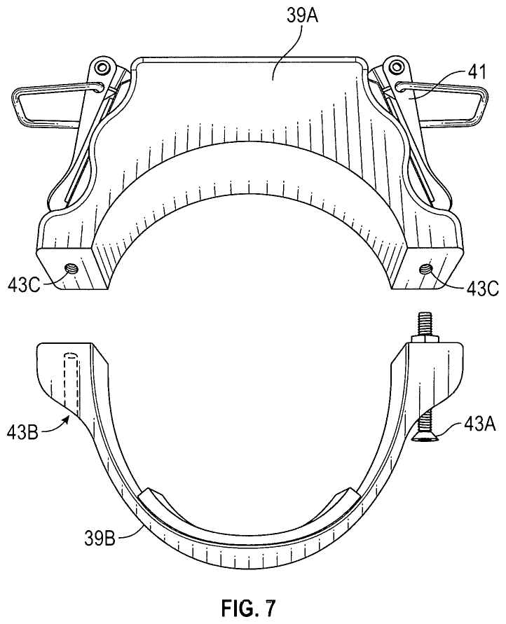

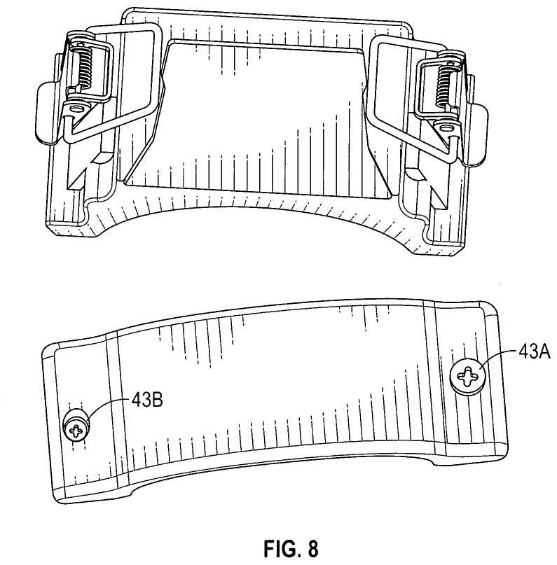

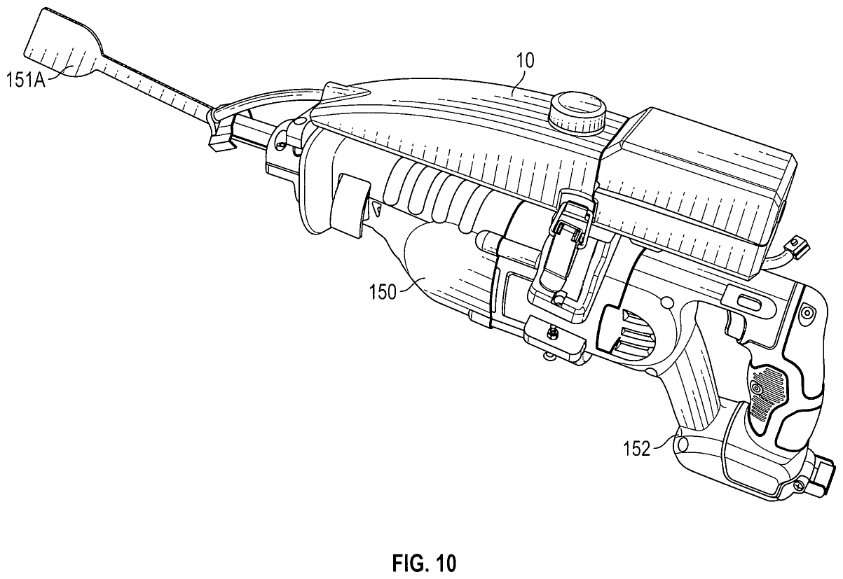

Body 11 also includes two opposed side recesses 2 and a pair of respective tabs 22, the purpose for which can be seen in FIG. 10; namely to serve as connection points for the hasps of the attachment clamp shown in FIGS. 7 and 8.

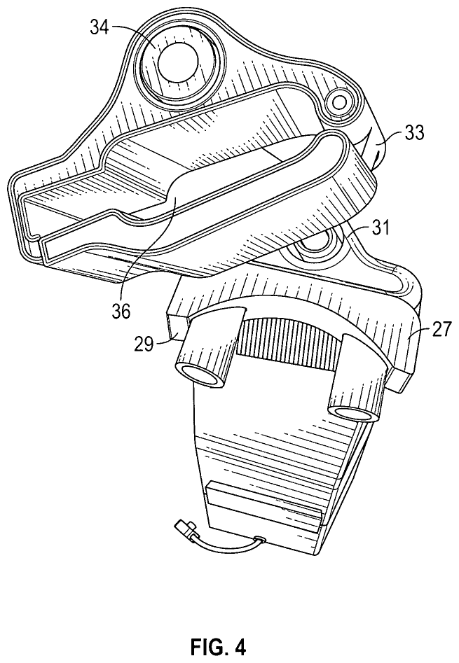

Also seen in FIG. 1, and more particularly in FIG. 4 is element 27, the connected mounting foot and which has two downward extending spaced tubes 29, each having about a ¼ inch interior diameter. These tubes are discussed infra. Downward facing foot 27 has a rear mounting plate 25 that includes a top surface groove not seen, into which a foot attachment plate 28 cemented or otherwise secured to the forward underside of the body 11 slides to secure the foot to the body 11. While the shape of the foot per se can vary due to the ability to mount the sprayer on various powered extractors, the presence of the foot attachment plate 28 on the underbody and the need for same will remain unchanged.

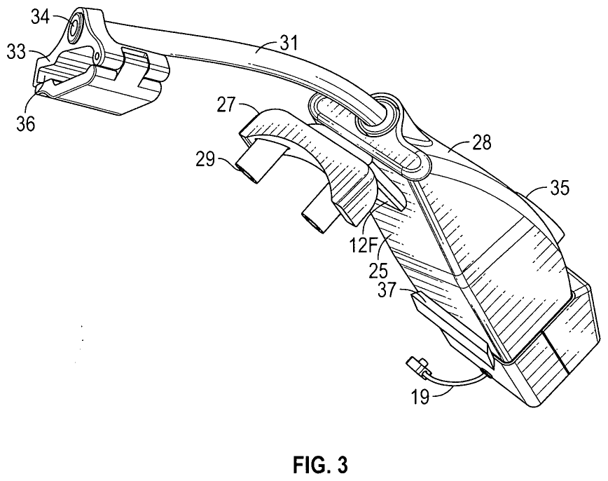

FIG. 2 is a perspective view of the left side of this device and is similar in appearance to the right side surface. Here however, the hose 31 for the delivery of lubricant can be seen in full emanating from the front nose 12F of the body 11. Blade holder 33 is also seen in this view. This element will be discussed infra. Note also the presence of identifying indicia decal 23 on the left and right side surfaces of the main body 11. The upper or top surface 12A of body 11 tapers downward to a short elevation front wall or surface 12F—see FIG. 3-. While cosmetically appealing, this tapering of the upper surface serves utilitarian purposes as well. First, it allows for better visibility of the work point where the extractor blade is in use. And second, since windshields are placed in vehicles at various angles and never at 90 degrees vertical, the tapered front end allows for easier access to the work site by the worker without hitting the windshield.

In FIG. 3, we see the device standing vertically on its battery holder and pump compartment rear surface. Here the underside of the device is seen wherein plate 37 overlaps the junction between the battery holder 33, and the main body 11's rear wall 12E. Also seen is foot 27 with the two spaced apart short tubes 29. Each tube 29 is about ½ inch in length and each has a ¼ inch diameter internal opening. The foot and its tubes are used to further support the device body 11 on an extractor gun. A pair of bolts of a longer length, are to be employed to replace the bolts found in a particular model extractor gun, such that when the shorter bolts are removed the longer ones can each pass through one of the holes of this foot and be threaded into aligned threaded bores in the gun to retain the forward end of the device in a steady position. Other front feet will mount differently for support on the gun.

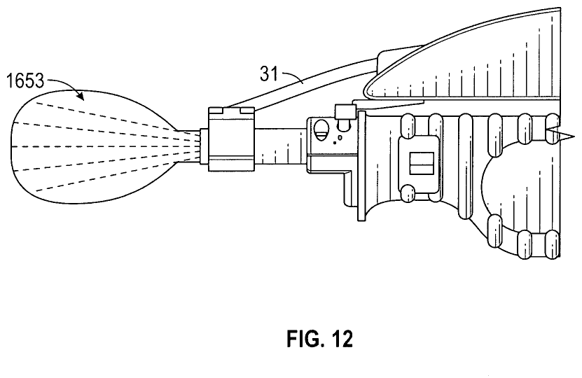

FIG. 4 is a closeup view of the foot 27 and spaced tubes 29 aforementioned as well as the hose 31, previously identified in FIG. 2. The purpose of the hose 31 is for delivery of lubricant such as water or glycerine or lubricating oil to the surface where the glass is in the process of being removed from a vehicle. Surrounding the nozzle 34 is blade holder 33 with a slot 36 that slides over the knife blade of the extractor tool to help direct the lubricant from the nozzle onto the blade. See FIG. 10 and FIG. 12.

Further discussion about the process of fluid delivery will be set forth in the discussion of the interior components of this device.

In FIG. 5, the bottom plan view, pigtail 19 is seen at the proximal end of the device. This element may serve to connect the device 10 to the extractor tool 150 electrically, such that when the trigger is pulled on the extractor gun—which gun forms no part of this invention—lubricating fluid 155 is dispersed onto the blade 160 from the spray nozzle 34. See FIG. 12. In the alternative, the pigtail can terminate in a manual actuator button for the device. See infra.

Moving forward on the bottom surface 12D one sees the plate 37 which serves as a reinforcement for the pump holder attached to the rear of the body 11. This plate is optional and depending on materials used, it can be eliminated. Adjacent the plate on opposite extremes thereof are small bolts 18A which thread into tapped openings 18B. One of each 18A and 18B are seen in this view. These bolts retain the pump compartment 13 to the battery cover 15.

Moving still forwardly to the distal end of the bottom surface a generally rectangular plate 28 is seen adhesed to the underside of the body 12D, to which the foot 27 is attached. Foot 27 has a rearward extending mounting plate 25, with an unseen groove on its upper surface, slightly wider than foot plate 28 and has a stop edge, such that the foot can slide onto foot plate 28 as shown in FIG. 5. If desired foot mounting plate 25 can be glued to plate 28, but such action will limit the utility of the device to one particular brand and model of extractor tool.

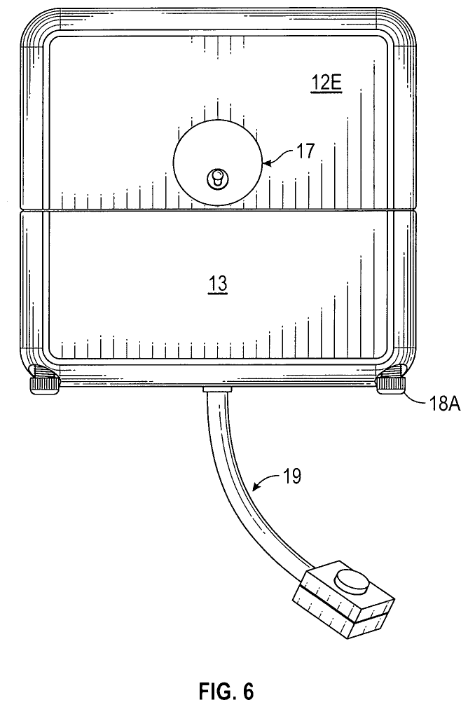

In FIG. 6, which is a rear elevational view, the pigtail aforementioned is seen as well as the battery charging port 17 which port is mounted conventionally on rear body surface 12E.

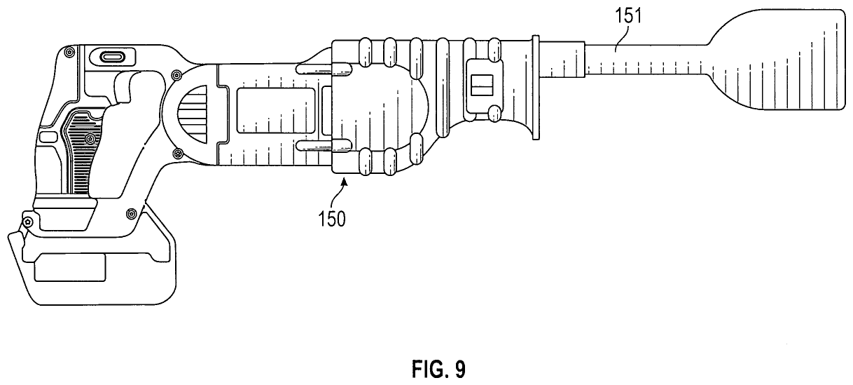

In FIGS. 7 & 8 we have front face views and top and bottom surface views of a two part clamp 39 formed of upper section 39A and lower section 39B which when engaged is used to attach the lubricant delivery device of this invention, 10, to a glass removal tool such as 150 shown in FIGS. 9 & 10. It is seen that the hasps 41 which are conventionally available fit into the respective side recesses 31 behind the respective tabs 22 to hold the clamp 39 to the device 10. Lower section 39B fits underneath the gun(extractor tool) and upper section 39A fits over the top of the gun and is attached by threaded bolts 43A that pass through bores 43B into aligned bores 43C found in the underside of the upper section 39A of the clamp 39.

Since the specific shape of the two sections of the clamp is dependent upon the specific configuration of the extractor tool, further discussion of the shape of the clamp 39 is not necessary. For this clamp, the two hasps of the clamp 39 fit respectively into the recesses 21 adjacent tabs 22 on each respective side face of the inventive device to secure the sprayer 10 to the extractor gun 150. Other attachment clamps and other attachment means to connect the device 10 to an extractor gun 150, are within the skill of the art.

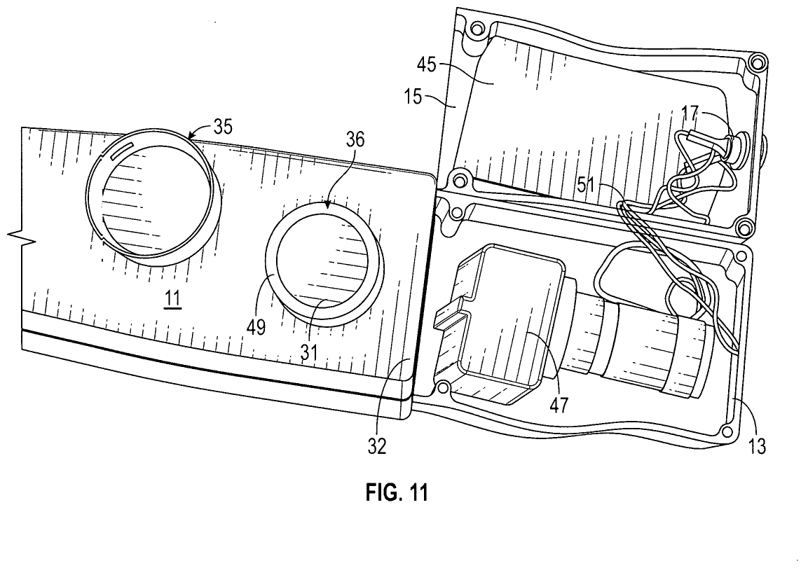

Let us turn now to FIG. 11. Here in a top closeup view, the threaded cap 35 has been undone from the closure 36 showing the lubricant chamber 49 inside the body 11 of the device. While a threaded cap is shown, a squeeze to release cap such as are found on mouthwash and other medicament bottles may be employed instead.

Battery cover 15 seen in FIG. 1 is here seen from the inside in FIG. 11. A series of four bolts that pass vertically upward through the pump compartment mate with aligned threaded bores in the battery cover 13 to hold the two sections together and thus attach the cover, 15, which holds the battery, to the pump compartment 13, whose interior is also seen in this view. The battery preferably employed is an 11.1 volt rechargeable battery sold under the Powerizer brand and made by AA Portable Power Corporation of Richmond, Calif., which battery may retained in the battery cover 15 by adhesive or hook and loop tabs, not seen, or it may merely be retained by the charge port which overlies it, as seen in FIG. 11.

The pump seen here is a 6-12 volt unit made by Gikfun of China. but other manufacturers make similarly suitable pumps. This pump has a capacity 1.5 to 1.8 liters per minute and has an inlet opening of 5 mm. It was originally designed for use with aquariums.

Also seen in this view is the output hose 31 which is connected from the pump 47 and which hose extends through the fluid chamber 49 and out the front or nose 12F, of the device to nozzle 34, which nozzle is seen in FIG. 4. Note how the nose has been sculpted roundwardly to accommodate the presence of the hose upwardly resembling the an engine housing of a DC −3.

Interposed optionally on the hose within the confines of the body 11 is an optional misting filter, which is not visible in the FIGURES. The lower hose, 52, adjacent thereto seen also connected to the pump, is the intake or input hose 32 that extends from the fluid chamber to the pump 47. Battery 45, which is charged through connection of an A/C source through port 17 disposed on surface 12E of the body 11 per FIG. 6. The battery is electrically connected by wiring 51 to the pump 47. Another part of this wiring 51 connects the charging port to the battery.

FIG. 12 has been discussed supra. It should be pointed out that the extractor blade 151A in FIG. 10 has a slightly different shape from the blade seen in FIG. 12 which is numbered 153. Thus no error in nomenclature. Also for ease and convenience of understanding, in this diagrammatic presentation, the blade holder 33 has been omitted.

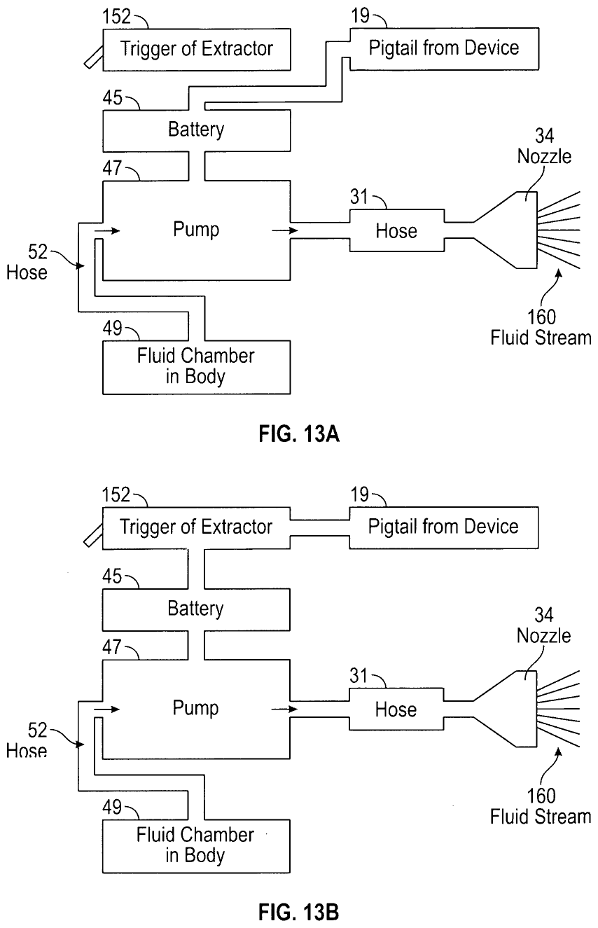

FIG. 13A is a diagram that explains the preferred mode of operation of the sprayer device of this invention. Here the pigtail 19 has a pushbutton actuator instead of an electrical connection to the gun at its terminus. When the button is actuated it electrically connects to the battery 45 such that, energy from the battery 45 urges the pump 47 to intake fluid via hose 52 from the body chamber 49 and push the fluid out hose 31 which is fluidly connected to the pump and then out the nozzle 34—seen in FIG. 4 onto the blade not shown here but seen in FIG. 12. This is the preferred mode, I.E. independent operation, because it has been deemed by professionals in the field, beneficial to lubricate the work site prior to commencing use of the extractor gun's blade. Indeed better control can take by adding fluid when deemed necessary to the blade and work site rather than having the liquid dispensed automatically on extractor gun actuation, which could cause excess fluid to be emitted for the situation at hand.

FIG. 13B is a diagram that explains a potential mode of the operation of this device. We see the trigger 152 of the Extractor gun—see FIG. 10—being electrically connected to the pigtail 19 of this invention, which trigger 152 is electrically connected to the battery 45 such that when the trigger is actuated, energy from the battery 45 urges the pump 47 to intake fluid via hose 52 from the body chamber 49 and push the fluid out hose 31 which is fluidly connected to the pump and then out the nozzle 34—seen in FIG. 4 onto the blade not shown here but seen in FIG. 12. This is an idealized mode of operation. The problem is, that this mode requires the gun owner or manufacturer to modify the gun 150 such that the pigtail can be electrically connected to the gun actuation system. Most gun manufacturers will be reluctant to do so. Therefore the preferred mode of operation is set out n FIG. 13A, wherein each device, the gun and the sprayer operate independently.

Note that the length of the pigtail can be adjusted as may be desired to suit different guns. Also the pigtail can be taped or retained by a strip of Velcro® closure at a suitable location on the gun, such that the gun can be actuated with the index finger, and the pushbutton for the sprayer actuated with another finger simultaneously or at different points in time.

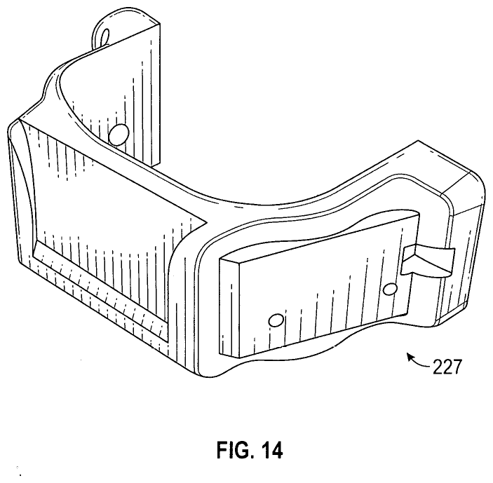

FIG. 14 is a perspective view of a variant of the front foot 227 discussed above. As can be seen it too, has a groove that will slide onto plate 28 on the bottom or underside of the device. This foot is intended for use with a gun other than the one shown in FIG. 10.

It is seen that I have created a device which is easily attached by one of several clamps designed for a specific battery operated or AC operated glass extractor gun. While I prefer the Equalizer brand of extractor gun or tool, this device can be adapted by a specific clamp and if needed a specific foot at the front, to fit other tools of this trade. My invention can also be adapted for use with other tools in other industries where the delivery of a lubricant or cooling fluid is needed at a work site.

In the testing of this device it has been found that the emitted lubricant both cools the work surface where the blade is hitting, and cools the blade itself. This makes glass removal easier, quicker and with added safety. Lubricants that can be used include water, water with a mild detergent, glycerine, and light mineral oil among others. Distilled water would be preferable to tap water even though more costly as it lacks minerals which could cause a clogging of the pump's operation.

As to manufacture, the body may be made of high impact plastic as well as aluminum. Stainless steel can be used as well but is expensive. Other steels can be employed provided that a liner or coating is used for the interior fluid chamber 49 to prevent rusting.

I claim:

1. A liquid sprayer device to be mounted on the top of a powered vehicle glass extractor gun, for emitting fluid upon actuation, to a vehicle glass work site and to a blade mounted in the glass extractor gun,
said device comprising a main body with three compartments, having a proximal end and a distal end, with a top surface, a right side wall, spaced from a parallel left side wall, a bottom surface spaced from and parallel to said top surface, an intermediate closed rear wall, and a front nose, the sidewalls being normal to the top surface and bottom surface, thereby defining a lubricant storage compartment;
a battery compartment and a pump compartment both physically connected rearwardly of said lubricant storage compartment, on said body,
the said lubricant storage compartment in said body having an input opening and a closure, and being fluidly connected to an rechargeable battery operated pump, both the battery and the pump being disposed in their respective compartments in said body, and which pump is connected to a fluid input hose from the lubricant storage compartment and the pump is also connected to a second hose which extends forwardly through the distal end of said body, said second hose having a blade holder thereon, through which a blade for the extractor gun is disposed, and actuator means,
such that when the device is actuated by the actuator means, fluid is sprayed on the extractor gun blade and the work site from the lubricant storage compartment.

2. The device of claim 1 wherein the front nose is of a lesser elevation than the rear wall of the lubricant storage compartment.

3. The device of claim 1 wherein a clamp means is used to attach the device to the extractor gun.

4. The device of claim 1 wherein the pump compartment is at the proximal end of the body behind the lubricant storage compartment, and the battery is stowed in a cover that overlies the pump compartment.

5. The device of claim 1 wherein the actuator is a push button on the end of a pigtail coming from the rear of the body and the battery compartment includes a recharging port.

6. The device of claim 5 wherein the pigtail emanates from the bottom of the pump compartment.

7. The device of claim 1 wherein the closure for lubricant storage compartment is a threaded cap.

8. The device of claim 1 further including a retainer front foot on the bottom surface of said device at the distal end of said body to help retain said device on an extractor gun.

9. The device of claim 8 wherein the said second hose extends forwardly of and beyond said front foot.

10. The device of claim 1 wherein a plate is disposed on the bottom surface of said body at the distal end thereof, for engagement with a removable foot, and wherein said removable foot has a foot plate with a groove therein for engagement with said plate.

11. A liquid sprayer device to be mounted on the top of a powered vehicle glass extractor gun, for emitting fluid upon actuation, to a vehicle glass work site and to a blade mounted in the glass extractor gun,
said device comprising a main body of three compartments, made of metal or plastic, and having a proximal end and a distal end, with a top surface, a right side wall, spaced from a parallel left side wall, a bottom surface spaced from and parallel to said top surface, a closed intermediate rear wall, and a front nose, thereby defining a lubricant storage compartment;
a battery compartment, and a pump compartment physically connected rearwardly of said lubricant stomp compartment, the battery compartment overlaying and being removably connected to the pump compartment;
the said lubricant storage compartment in said body having an input and a closure, and being fluidly connected to a rechargeable battery operated pump, both the battery and the pump being disposed in said respective compartments, and which pump is fluidly connected to a fluid input hose from the lubricant storage compartment and the pump is also connected to a second hose which extends forwardly through the distal end of said body, said second hose having a blade holder thereon, through which a blade for the extractor gun is disposed;
and an actuator means,
such that when the device is actuated by the actuator means, fluid is sprayed on the extractor gun blade and the work site from the lubricant storage compartment.

12. The device of clamp 11 wherein there are opposed recesses and tabs on opposite sides of the body adapted to receive hasps from a clamp to be used to mount the device to an extractor gun.

13. The device of claim 12 further including a two part clamp having a pair of opposed hasps for engagement with the tabs and recesses on the body of he device.

14. The device of claim 12 wherein a plate is disposed on the bottom surface of said body at the distal end thereof, for engagement with a removable foot, and wherein said removable foot has a foot plate with a groove therein for engagement with said plate.

15. The device of claim 14 wherein the said second hose extends forwardly of and beyond said front foot and the battery compartment includes a recharging port.
